(19) United States
(12) Patent Application Publication
(10) Pub. No.: US 2024/0214760 A1
(43) Pub. Date: Jun. 27, 2024

(54) SYSTEM AND METHOD FOR DYNAMIC AUDIO CHANNEL ORIENTATION

(71) Applicant: ARRIS ENTERPRISES LLC, Suwanee, GA (US)

(72) Inventors: Aldo David Sanchez RODRIGUEZ, Monterrey (MX); Javier Reyes SANCHEZ, General Escobedo (MX); Jose Alberto Gastelum MORENO, Apodaca (MX); Edgar Low CASTRO, Apodaca (MX); Alberto Ornelas CARLIN, Apodaca (MX)

(73) Assignee: ARRIS ENTERPRISES LLC, Suwanee, GA (US)

(21) Appl. No.: 18/284,925

(22) PCT Filed: Feb. 22, 2022
(86) PCT No.: PCT/US22/17237

§ 371 Date: Sep. 29, 2023

Related U.S. Application Data
(60) Provisional application No. 63/171,853, filed on Apr. 7, 2021.

(51) Int. Cl. H04S 7/00; G06F 3/01; G06F 3/16; H04R 3/12; H04R 5/04; H04S 3/00

(52) U.S. Cl. CPC H04S 7/303; G06F 3/012; G06F 3/165; H04R 3/12; H04R 5/04; H04S 3/008; H04R 2420/07

(57) ABSTRACT

A system and method for dynamically adjusting channel orientation as a function of a listener's orientation. The invention employs a spatial mapping of the plurality of audio transducers within a given listening space and routes the audio output intended for each of the transducers based upon the orientation of a listener within the space. Ideally, the listener's orientation is determined via a sensor worn, held or otherwise affixed to the listener.

### BACKGROUND OF THE INVENTION

Audio systems, of varying degrees of complexity, are found in many residential environments. These systems are often coupled to or fully integrated with video entertainment and gaming systems. The audio systems can be as simple as two-channel stereo or more complex multi-channel arrangements, such as 5.1 audio (6 distinct channels, plus a subwoofer) and 7.1 audio (8 distinct channels, plus a subwoofer). The speakers or audio transducers associated with such systems can be wired or wireless.

A listening to such audio systems may simply be experiencing a casual listening experience, not particularly mindful of sonic qualities or the placement of the various speakers providing the sound. However, many listeners can be more discerning, if not critical of the listening experience. Such listeners may be quite mindful of the particular channel or channels (and the associated speaker or speakers) that particular sounds or particular instruments or vocals are intended to arise from. For example, assume a critical listener is listening to a favorite orchestral selection, and expects that during a certain movement the strings will come in from the front left speaker. If the strings unexpectedly came in from the rear left speaker, the enjoyment of the music might be compromised. In addition, many multi-channel musical recordings use a panning effect, shifting certain instruments from left to right or front to back. This is can be done to induce a feeling of movement in the listener, or to give the effect of expanding or contracting the sonic space of the listening area. An unexpected juxtaposition of the channels, and therefore the direction of the audio effect could result in a less than optimal listening experience.

Although one would not expect an audio system to randomly switch the orientation of the speakers within a given listening area, that is precisely what happen from a listener's frame of reference when that listener simply rotates their orientation within the listening space. For example, as shown in FIG. 1A, the listener (102) is in a first orientation, facing the front of listening space 104 and listening to 2-channel audio source 106 via right speaker 108 and left speaker 110. In this first orientation, the listener's right ear (112) is closest to the speaker (108) producing sound provided by right audio channel of 2-channel audio system 106, and the listener's left ear (114) is closest to the speaker (110) producing sound provided by left audio channel of 2-channel audio system 106. Sounds intended to be heard as originating from the left portion of the listening area are perceived as originating from the listener's left. Sounds intended to be heard as originating from the right portion of the listening area are perceived as originating from the listener's right.

However, as shown in FIG. 1B, listener 102 has reoriented themselves so that they are now facing the rear of the listening space 104. In this orientation, sounds intended to be heard as originating from the left speaker (110) are perceived as originating from the listener's right. Sounds intended to be heard as originating from the right speaker are perceived as originating from the listener's left. This juxta-positioning is further exacerbated in system where there are from and rear speakers involved. When the listener rotates 108°, in addition to having left and right switched around, front becomes rear and rear becomes front.

Consequently, it would be advantageous to provide for a system and method whereby an audio system dynamically adjusts channel orientation as a function of the user's orientation.

### BRIEF SUMMARY OF THE INVENTION

A system and method for dynamically adjusting channel orientation as a function of a listener's orientation. The invention employs a spatial mapping of the plurality of audio transducers within a given listening space and routes the audio output intended for each of the transducers based upon the orientation of a listener within the space. Ideally, the listener's orientation is determined via a sensor worn, held or otherwise affixed to the listener.

### BRIEF DESCRIPTION OF THE DRAWINGS

The aspects, and advantages of the present invention will become better understood with regard to the following description, appended claims, and accompanying drawings in which:

FIG. 1A is a simplified functional diagram of a user in a first orientation within a listening area.

FIG. 1B is a simplified functional diagram of a user in a second orientation within the listening area of FIG. 1A.

FIG. 2A is a simplified functional diagram of a first preferred embodiment for a system adapted to dynamically select an audio source as a function of a user's orientation, depicting a listener in a first orientation.

FIG. 2B is a simplified functional diagram of a system of FIG. 2A depicting the listener in a second orientation.

FIG. 2C is a s simplified functional diagram of a system of FIG. 2A depicting the listener in a third orientation.

FIG. 3 is depiction of a behind-the-ear wireless device adapted to be utilized in the system of FIG. 2A.

FIG. 4A is a side view of a particular embodiment of the wireless device of FIG. 3.

FIG. 4B is a rear view of the wireless device of FIG. 3.

FIG. 4C is a top view of the wireless device of FIG. 3.

FIG. 5 is a flow diagram of a process supported within the system of FIG. 2A.

FIG. 6A is a simplified functional diagram of a second preferred embodiment for a system adapted to dynamically route multi-channel audio as a function of a user's orientation, depicting a listener in a first orientation.

FIG. 6B is a simplified functional diagram of a system of FIG. 6A depicting the listener in a second orientation.

FIG. 7 is a flow diagram of a process supported within the system of FIG. 6A.

FIG. 8A is shows a line-of-sight device compatible with the systems of FIGS. 2A and 6A integrated with a pair of glasses.

FIG. 8B is shows a line-of-sight device compatible with the systems of FIGS. 2A and 6A attached to a pair of glasses.

FIG. 8C is shows a line-of-sight device compatible with the systems of FIGS. 2A and 6A attached to a headband.

FIG. 8D is shows a line-of-sight device compatible with the systems of FIGS. 2A and 6A integrated with a hat.

### DETAILED DESCRIPTION

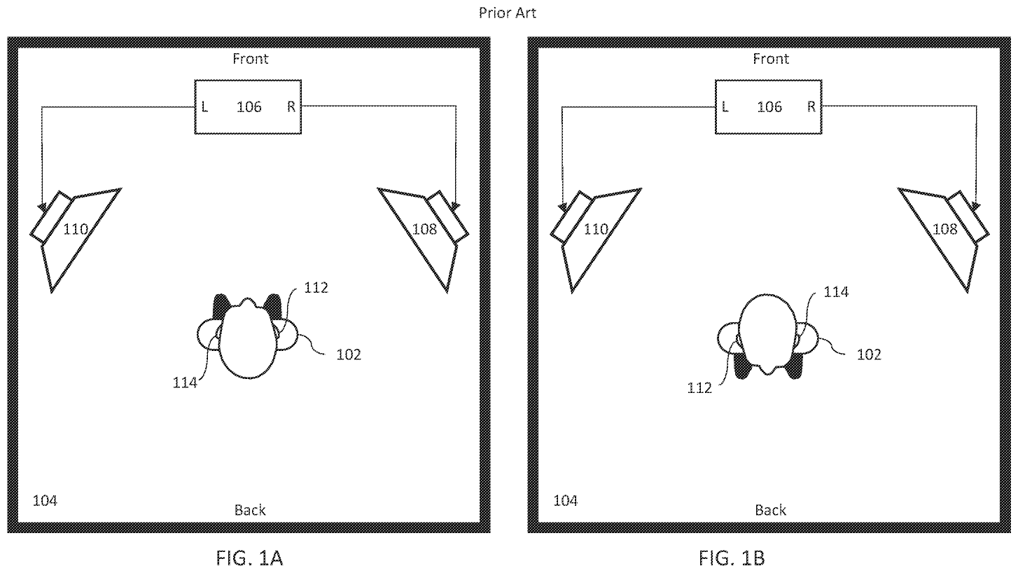

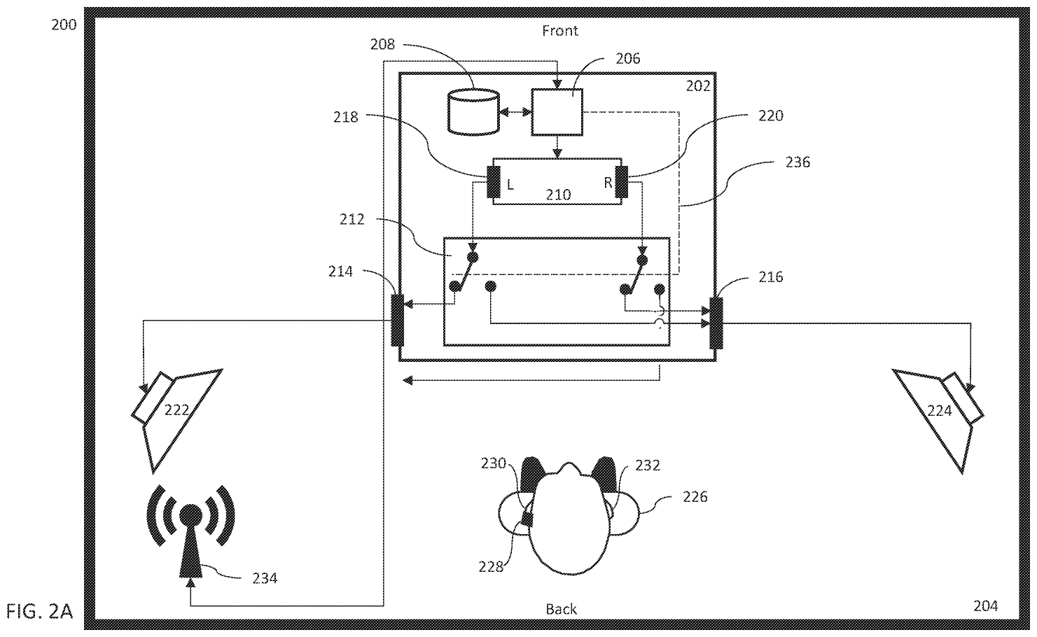

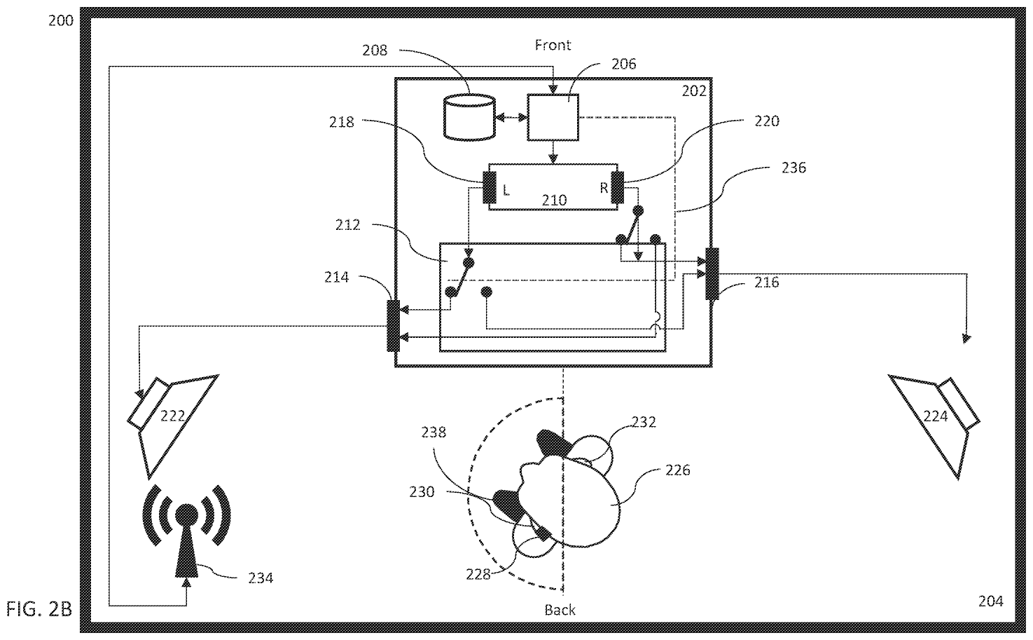

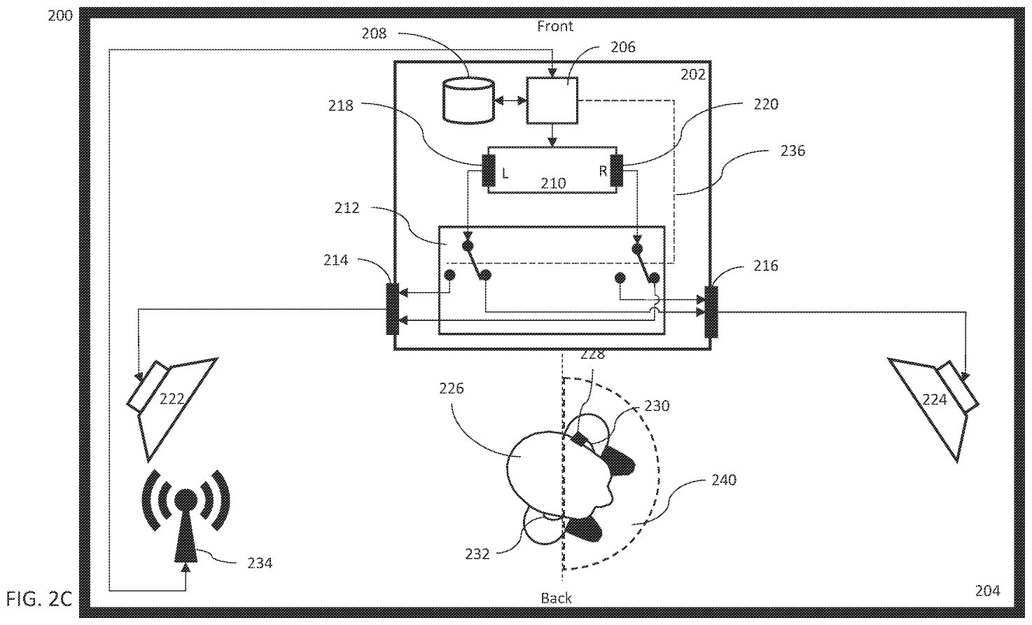

FIG. 1 is a functional diagram of a first preferred embodiment of a system (200) for dynamically adjusting channel orientation as a function of a listener's orientation. As shown, 2-channel audio system 202 is situated within listening space 204. Audio system 202 includes controller 206, memory 208, 2-channel audio source 210, router 212, and audio output terminals 214 and 216. Audio source 210 is shown to have a left audio output (218, L) and a right audio output (220, R). Speaker 222 is shown to be driven by audio driver terminal 214 and speaker 224 is shown to be driven by audio driver terminal 216. Also depicted in FIG. 2A is listener 226. Listener 226 is shown to be facing the front to listening space 204. An ear-mounted wireless directional device (228) is shown to be positioned upon listener 224's left ear (230). Listener 224's right ear (232) is also depicted.

Directional device 228 is adapted to detect, store and transmit information indicative of the device's relative position within listening area 204 with respect to wireless transceiver 234, as well as information indicative of the orientation of directional device 228. Numerous approaches for the indoor localization of wireless devices are known in the art, including those relying upon one or more of the following: received radio signal strength (“RSS”), radio fingerprint mapping, angle of arrival sensing, and time of flight measurements. The present state-of-the-art provides for employing these approaches, or combinations of these approaches, to permit device localization within wireless systems utilizing single or multiple transceiver arrangements.

Controller 206 is adapted to utilize information stored in memory 208 to support wireless communication with directional device 228 via wireless transceiver 234, which is situated within listening area 204. Wireless transceiver 234 is positioned so as to ensure that signals broadcast from it propagate throughout listening area 104. Wireless transceiver 234 can employ any wireless system and protocol capable of supporting the transmission of digital content (IEEE 802.11 Wi-Fi, 802.15 ZigBee, and Bluetooth being examples of such). In addition, wireless transceiver 234 could comprise a single transceiver or multiple discrete transceivers.

Controller 206 is also shown to control router 212 (represented by dashed line 236). Router 212 is adapted to selectively connect left audio output 218 to a given one of the driver terminals (214, 216) while concurrently connecting right audio output 220 with the alternate one of the driver terminals (214, 216). This router can be comprised of one or more physical or virtual switches. The control of router 210 is a function information stored within memory 208 and positional/orientation information received from directional device 228. The information stored within memory 208 comprises at least a positional mapping of speakers 222 and 224 relative to wireless transceiver 234 within listening area 204.

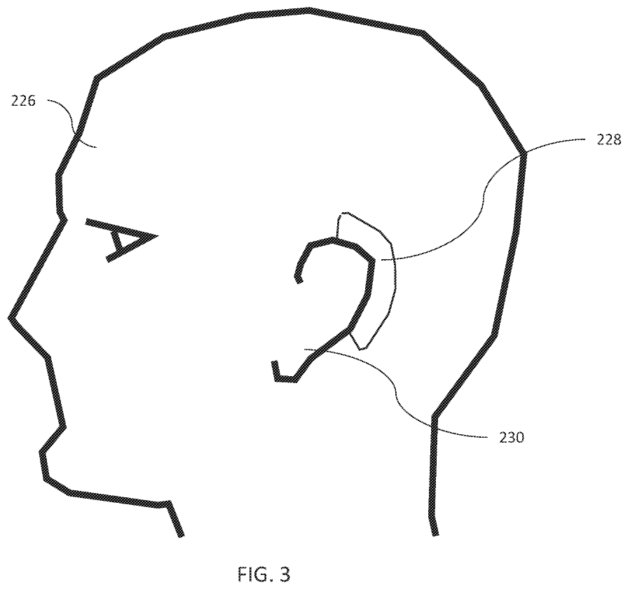

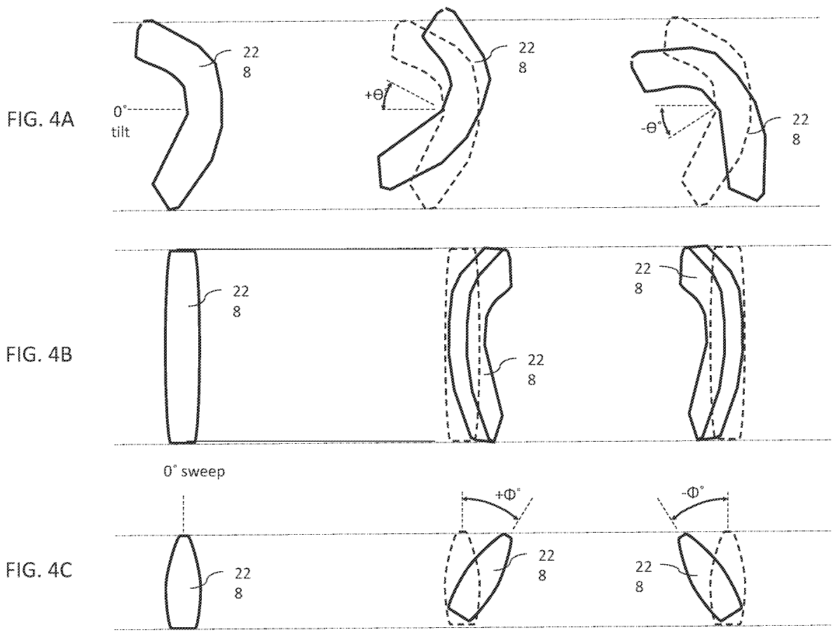

FIGS. 3 and 4A-C provide more detailed depictions of one embodiment of directional device 228. As shown in FIG. 3, this particular embodiment is adapted to be worn behind the ear of a listener. FIG. 4A shows a side view of directional device 228 as it rotated in the y-plane from a position of 0° to a position of +θ° and then −θ° (referred to as the tilt angle). FIGS. 4B and 4C show a rear and top view, respectively, of directional device 228 being rotated in the x-plane from a position of 0° to a position of +Φ° and then −Φ° (referred to as the sweep angle). Directional device 228 comprises a sensor to detect and measure relative movement in both the x-plane and y-plane. Such sensors are well known in the art are typically comprised of orthogonally-situated accelerometers of gyroscopic sensors that convert measured acceleration (or displacement in the case of gyroscopic sensors) to numerical values. These numerical values, indicative of the orientation of directional device 228, would then be transmitted to wireless transceiver 234.

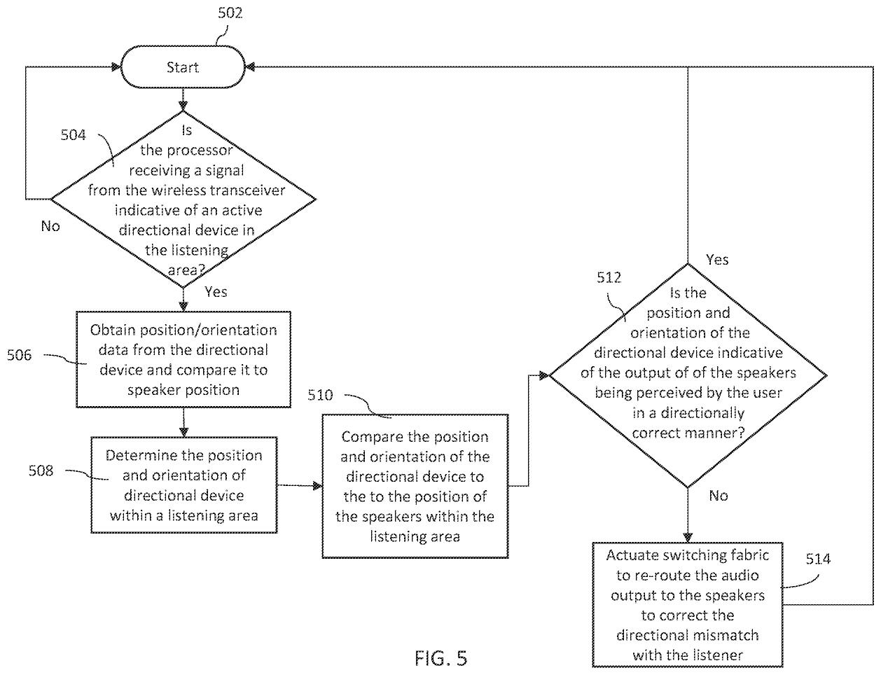

As previously mentioned, controller 206 is adapted to utilize information stored in memory 208 (including the information related to the relative positions of speakers 222 and 224 with respect to wireless transceiver 234), along with the positional/orientation data received from directional device 228 via wireless transceiver 234 to control router 212. The process enabling this is illustrated in the flow diagram of FIG. 5.

The process initiates when processor 206 tests for the reception of wireless transceiver 234 data indicative of an active directional device (228) in listening area 204 (steps 502 and 504). Upon confirmation of such, processor 206 obtains data indicative of the position and orientation the directional device from wireless transceiver 234 and data indicative of the relative positions of speakers 222 and 224 within listening area 204 from memory 208 (step 506). Controller 206 then determines the location/orientation of directional device 228 (step 508) and compares it to the known positions of speakers 222 and 224 within listening area 204 (step 510).

Controller 206 then performs a calculation to determine if the position and orientation of directional device 228 (located upon the listener's left ear) is indicative of the output of speakers 222 and 224 being perceived as directionally correct by listener 226 (conditional 512). In the case of system 100, the test would be if the listener's left ear was oriented so that it was primarily receiving sound from speaker 222, which is presently connected to the left audio output 218 of audio system 202. The angular sweep of the positions/orientations in which directional device 228 (and consequently the listener's left ear (230)) is indicated by region area 238 of FIG. 2B. If the directional device is determined to be within this region (an affirmative result of conditional 512), controller 206 will take no action. The process reverts back to step 502 and begins anew.

However, if conditional 512 yields a negative result, perhaps due to directional device 228 being positioned/oriented so that it is within angular area 240 of FIG. 2C, the process continues with step 514. In this step controller 206 actuates the switches within router 212 so as to connect left audio output (218) of audio system 202 to speaker 224, and the right audio output (220) of audio system 202 with speaker 222. The speaker output would be substantially correct given listener 226's position, with left ear 230 being substantially positioned to hear left audio content from speaker 224 (see FIG. 2C). The process then reverts to step 502 and starts anew.

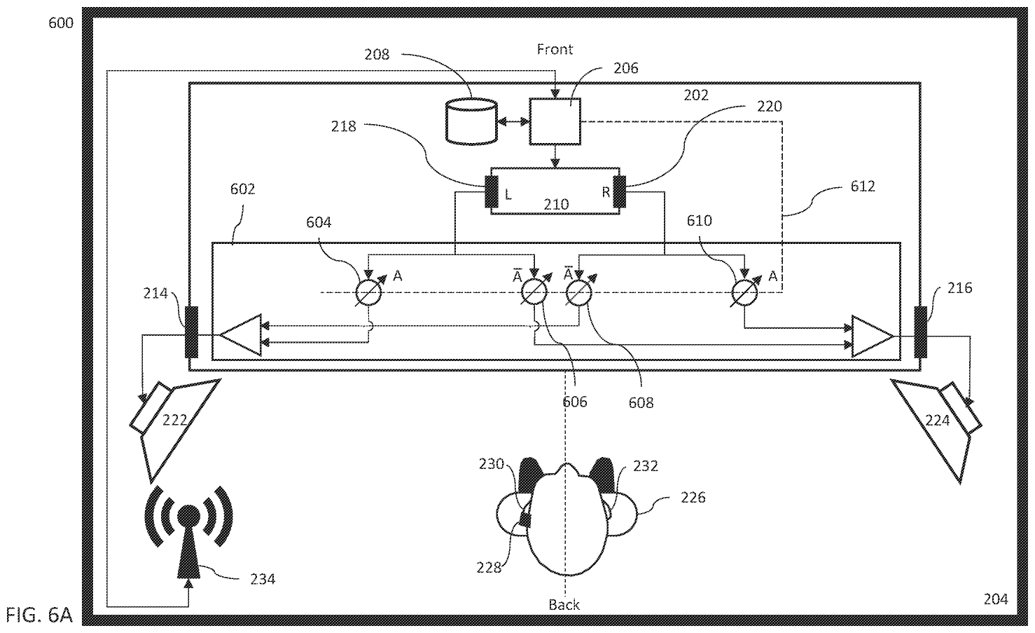

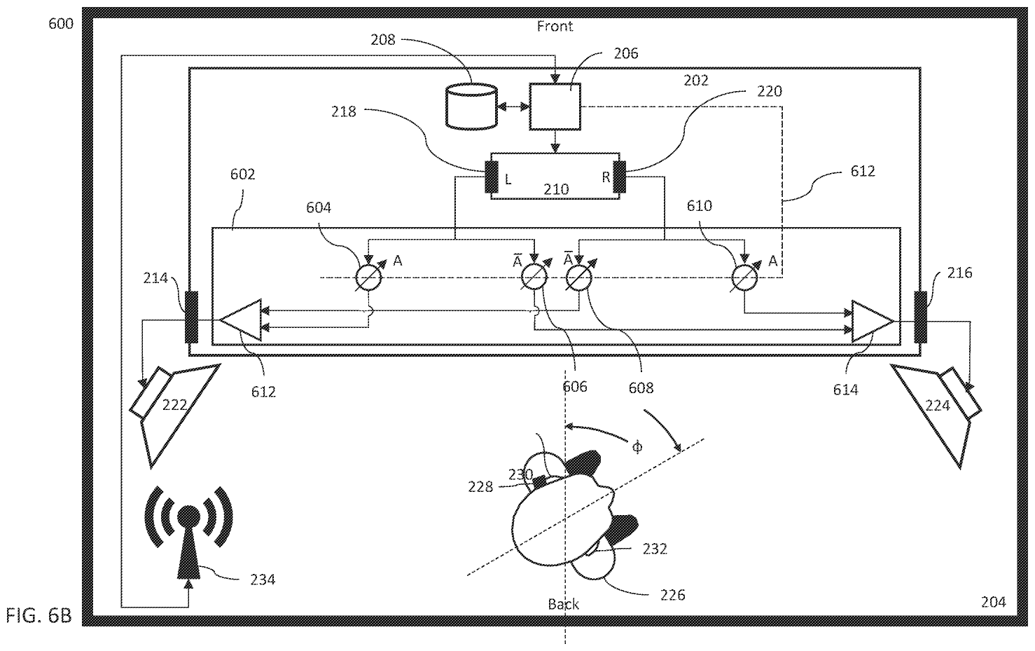

FIG. 6A depicts a system (600) that supports an alternate embodiment of the invention. This system shares many elements with system 200 (FIGS. 2A-C) and these elements are denoted with the same numerical labels utilized in FIGS. 2A-C. However, the switches within router 212 have been replaced with audio attenuator bank 602. As shown the attenuator bank receives the left and right audio signals, respectively, from audio output terminals 218 and 220. Each of these signals is feed to a pair of complementary attenuators; the left output feeding attenuators 604 and 606, the right output feeding attenuators 608 and 610. Each of these complementary pairs is adapted to attenuate the incoming audio signal so that the output of the attenuator designated A is inversely proportional to the output of the attenuator designated Ā. Furthermore, the attenuator pairs are adapted so that the combining output of attenuator A plus that of attenuator Ā would result in a signal having substantially the same amplitude as the original incoming audio signal. The attenuator pairs are shown to be controlled by processor 206 (represented by dashed line 612).

Processor 206, in accordance with information stored within memory 208 and positional/orientation information received from directional device 228, is adapted to control attenuator bank 602 as a function of the orientation of directional device 228. The control of the switches within router 212 in system 200 caused an abrupt inversion of the speaker driving signals (from left to right and right to left) upon directional device 228's orientation traversed a critical angular sweep. Contrastingly, attenuator bank 602 provides a gradual transition as a function of the angular orientation of the directional device 228. The degree of attenuation of the complementary attenuators being determined as function of the angle ϕ, as sensed by directional device 228 (see FIG. 6B). This angle measures the angle by which the directional device (and consequently the listener's left ear (230)) is offset from a position wherein the listener's left ear was substantially aligned with speaker 222 and the listener's right ear was substantially aligned with speaker 224 (see FIG. 6A). The degree of attenuation, A and Ā, is calculated by processor 206 in accordance with the following equations:

$$A = ( \frac{\vert 180 - ϕ \vert}{180} )$$

$$\overline{A} = 1 - ( \frac{\vert 180 - ϕ \vert}{180} )$$

Table A, below, provides values for A and Ā at 30° intervals of directional device 228 (and therefore listener) orientation offset. The complementary nature of the attenuator pairings is also evident from the values in Table A. As shown, the inversely proportional signal amplitudes output from the paired attenuators results in a signal strength of 100%.

| ϕ | A | Ā | A + Ā |
|---|---|---|---|
| 0 | 100.00% | 0.00% | 100% |
| 30 | 83.33% | 16.67% | 100% |
| 60 | 66.67% | 33.33% | 100% |
| 90 | 50.00% | 50.00% | 100% |
| 120 | 33.33% | 66.67% | 100% |
| 150 | 16.67% | 83.33% | 100% |
| 180 | 0.00% | 100.00% | 100% |
| 210 | 16.67% | 83.33% | 100% |
| 240 | 33.33% | 66.67% | 100% |
| 270 | 50.00% | 50.00% | 100% |
| 300 | 66.67% | 33.33% | 100% |
| 330 | 83.33% | 16.67% | 100% |
| 360 | 100.00% | 0.00% | 100% |

As shown in FIGS. 6A an 6B, the output of attenuator 604 and the output of attenuator 608 are input to additive buffer 612. This results in the summing of [A(left audio)+Ā(right audio)] being evident at the output of additive buffer 612. Similarly, the output of attenuator 606 and the output of attenuator 610 are input to additive buffer 614., resulting in the summing of [Ā(left audio)+A(right audio)] being evident at the output.

This results in the signals driving speakers 222 and 224 being inversely proportioned additive mixtures of the left and right audio signals output from 2-channel audio source 210. As the angular orientation of listener 226 (as sensed by directional device 228) varies, the mixing of the left and right audio signals driving each of the speakers (222, 224) will vary as a function of the offset angle Φ, thereby providing the user with a continuous audio transition as the left and right channel audio signals are gradually shifted between the speakers. This continuous audio experience may be preferred by some listeners that might find the abrupt switching of system 200 undesirable.

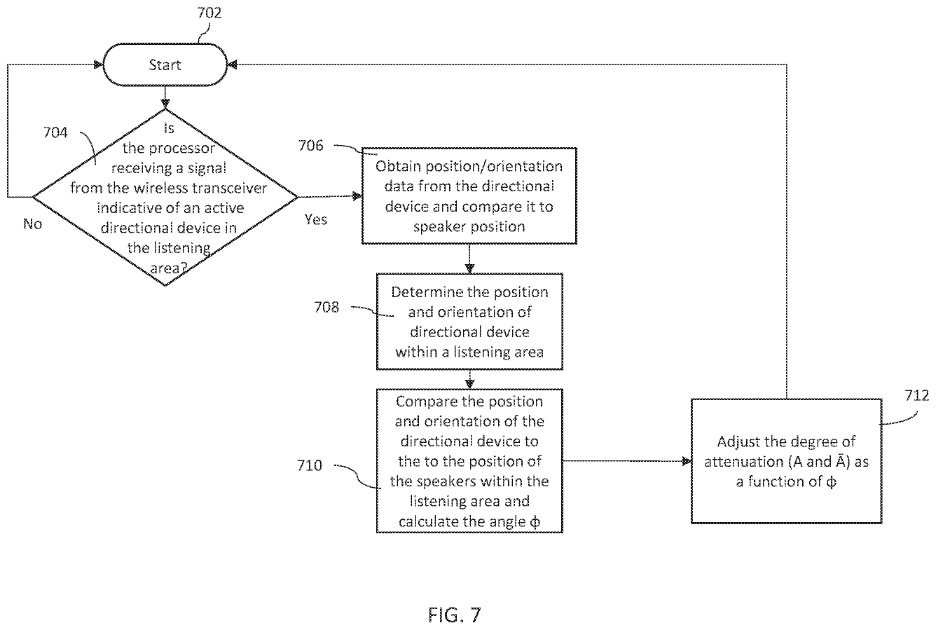

FIG. 7 illustrates the above-described process. As shown the process initiates when processor 206 tests for the reception of wireless transceiver 234 data indicative of an active directional device (228) in listening area 204 (steps 702 and 704). Upon confirmation of such, processor 206 obtains data indicative of the position and orientation the directional device from wireless transceiver 234 and data indicative of the relative positions of speakers 222 and 224 within listening area 204 from memory 208 (step 706). Controller 206 then determines the location/orientation of directional device 228 (step 708) and compares it to the known positions of speakers 222 and 224 within listening area 204 and computes the value of angle ϕ (step 710). Controller 206 then adjusts the degree of attenuation (A and Ā) in each of the pairs of complementary attenuators (step 712). The process then reverts to step 702 and starts anew.

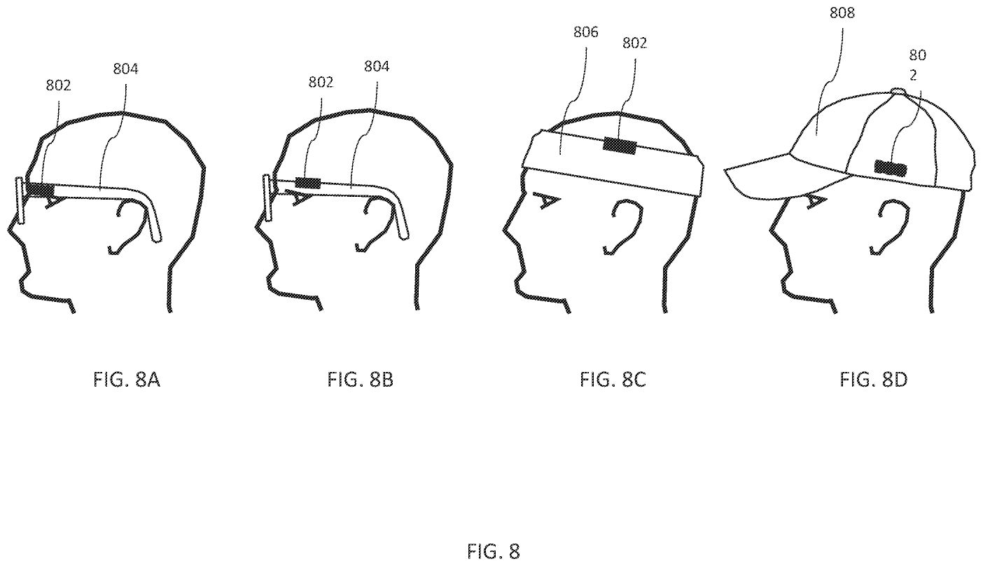

In all of the above embodiments the directional device (128) has been described as a behind-the-ear appliance in the above embodiment, however, it will be understood that there are numerous configurations for such a device that could be utilized. For example, as shown in FIGS. 8A-D. Directional device (802) could be embedded within a pair of glasses or goggles (804), clipped or embedded within a headband (806), or integrated into a cap, hat or other headgear (808).

Although the invention herein has been described with reference to particular embodiments, it is to be understood that these embodiments are merely illustrative of the principles and applications of the present invention. For example, the link between the audio routing system and the speakers be wired or wireless. The system could be adapted to recognize multiple directional devices within a single listening area, reactively route appropriate audio to the speakers in response to majority of the devices becoming oriented in a particular manner. Additionally, the audio routing system could be integrated into another device such as a set-top box, a media gateway device, a television, a digital assistant, a computer, etc. Furthermore, the controller could be adapted to control larger numbers of speakers, including those associated with surround sound systems such as 5.1 or 7.1 systems. In such cases audio outputs for front, rear, right left, front left, etc. would be routed or attenuated among numerous speakers so as to maintain the most directionally correct experience for the listener; the routing/attenuation being performed in accordance with the particular information in a memory associated with a system controller. All of the above variations and reasonable extensions therefrom could be implemented and practiced without departing from the spirit and scope of the present invention as defined by the appended claims.

1. A system for independently routing each of a plurality of audio signals, each of the audio signals having a particular directional association, to a plurality of audio transducers, each of the audio transducers being located in a particular spatial region within a listening area, the system comprising:
at least one router comprising:
at plurality of audio inputs each adapted for accepting one of the plurality of audio signals;
at plurality of two audio outputs, each adapted to provide a signal to one of the plurality of audio transducers; and
a routing matrix adapted to selectively route each of the plurality of audio signals to one of the plurality of audio outputs;
at least one sensor adapted to produce signals indicative of a user's position and orientation with respect to the plurality of audio transducers;
a wireless transceiver adapted to receive the signals produced by the at least one sensor; and
at least one controller adapted to:
determine, based, at in part, upon the signals received by the wireless transceiver, user's position and orientation in the listening with respect to the plurality of audio transducers; and
actuate the at least one router based, at least in part, on the determination so as to route at least a particular one of the plurality of audio signals to a particular one of the plurality of audio transducers.

2. The system of claim 1 wherein the signals indicative of the user's position and orientation comprise at least the sweep angle of the sensor with respect to at least one of the plurality of audio transducers.

3. The system of claim 1 wherein the sensor comprises at least one of:
at least one accelerometer; and
at least one gyroscopic sensor.

4. The system of claim 1 wherein the system for selecting a particular audio source from among a plurality of audio sources comprises a set-top box.

5. The system of claim 1 wherein the sensor comprises:
an earpiece;
eyewear; and
headgear.

6. The system of claim 1 wherein the system for independently routing each a plurality of audio signals selecting a particular audio source from among a plurality of audio sources comprises at least one of the following:
a set-top box;
a television;
a gaming system;
a computer monitor;
a tablet;
a smartphone;
an audio system; and
a digital assistant.

7. The system of claim 1 wherein the plurality of audio signals are associated with at least one of the following:
a two-channel audio system; and
a surround sound audio system.

8. The system of claim 1 wherein the wireless transceiver comprises at least one of:
a radio frequency transceiver;
a wi-fi transceiver;
a Bluetooth transceiver; and
a Zig-Bee transceiver.

9. The system of claim 1 wherein the switching fabric comprises at least one of the following:
a bank of audio attenuators;
a plurality of physical switches; and
a plurality of virtual switches.

10. The system of claim 9 wherein the bank of audio attenuators comprises a plurality of complementary audio attenuators.

11. A method for independently routing each of a plurality of audio signals, each of the audio signals having a particular directional association, to a plurality of audio transducers, each of the audio transducers being located in a particular spatial region within a listening area, in a system comprising:
at least one router comprising:
at plurality of audio inputs each adapted for accepting one of the plurality of audio signals;
at plurality of two audio outputs, each adapted to provide a signal to one of the plurality of audio transducers; and
a routing matrix adapted to selectively route each of the plurality of audio signals to one of the plurality of audio outputs;
at least one sensor adapted to produce signals indicative of a user's position and orientation with respect to the plurality of audio transducers; and
a wireless transceiver adapted to receive the signals produced by the at least one sensor;
the method comprising the steps of:
determining, based, at in part, upon the signals received by the wireless transceiver, user's position and orientation in the listening with respect to the plurality of audio transducers; and
actuating the at least one router based, at least in part, on the determination so as to route at least a particular one of the plurality of audio signals to a particular one of the plurality of audio transducers.

12. The method of claim 11 wherein the signals indicative of the user's position and orientation comprise at least the sweep angle of the sensor with respect to at least one of the plurality of audio transducers.

13. The method of claim 11 wherein the sensor comprises at least one of:
at least one accelerometer; and
at least one gyroscopic sensor.

14. The method of claim 11 wherein the system for selecting a particular audio source from among a plurality of audio sources comprises a set-top box.

15. The method of claim 11 wherein the sensor comprises:
an earpiece;
eyewear; and
headgear.

16. The method of claim 11 wherein the system for independently routing each a plurality of audio signals selecting a particular audio source from among a plurality of audio sources comprises at least one of the following:
a set-top box;
a television;
a gaming system;
a computer monitor,
a tablet;
a smartphone;
an audio system; and
a digital assistant.

17. The method of claim 11 wherein the plurality of audio signals are associated with at least one of the following:
a two-channel audio system; and
a surround sound audio system.

18. The method of claim 11 wherein the wireless transceiver comprises at least one of:
a radio frequency transceiver;
a wi-fi transceiver;
a Bluetooth transceiver; and
a Zig-Bee transceiver.

19. The method of claim 11 wherein the switching fabric comprises at least one of the following:
a bank of audio attenuators;
a plurality of physical switches; and
a plurality of virtual switches.

20. The method of claim 19 wherein the bank of audio attenuators comprises a plurality of complementary audio attenuators.
